(19) United States
(12) Patent Application Publication
(10) Pub. No.: US 2021/0380380 A1
(43) Pub. Date: Dec. 9, 2021

(54) AUTONOMOUS COIL HANDLING SYSTEM

(71) Applicant: Primetals Technologies USA LLC, Alpharetta, GA (US)

(72) Inventors: Margaret Gentile, Shrewsbury, MA (US); Jason Zelle, Worcester, MA (US)

(73) Assignee: Primetals Technologies USA LLC, Alpharetta, GA (US)

(21) Appl. No.: 16/891,235

(22) Filed: Jun. 3, 2020

(51) Int. Cl. B66F 9/075; B66F 9/24

(52) U.S. Cl. CPC B66F 9/0755; B66F 9/24

(57) ABSTRACT

An autonomous vehicle is described for use as part of a fleet of such vehicles used in coil handling. The autonomous vehicle has an on-board processor communicating with an external processor (e.g., an Artificial Intelligence (AI) processor) to receive and execute one or more instructions for automated operation of the autonomous vehicle, a robotic drive to move the autonomous vehicle based on the instructions received from the external processor; and a set of gripping mechanisms receiving the instructions and operating in one of two coil storage modes: a vertical mode and a horizontal mode. The instructions instructing the autonomous vehicle to handle one or more of the following coil handling tasks to move a coil: moving the coil after a reform stage, moving the coil after a trimming/inspection stage, moving the coil after a compacting stage, and moving coil to a storage location.

### BACKGROUND OF THE INVENTION

### Field of Invention

The present invention relates generally to the field of coil handling equipment. More specifically, the present invention is related to an artificial intelligence (AI) driven autonomous vehicle fleet for use as coil handling equipment.

### Discussion of Prior Art

Prior art current coil handling equipment convey coils from a reform station to a compactor. Some disadvantages with such prior art systems are that they are large, expensive to install, prone to breakdowns, and require frequent maintenance.

Such prior art systems consist of a large and inflexible conveyor system on which the coils are transported in a linear fashion as shown in FIG. 1. Particularly, the coils are transported from reform 102 to trimming/inspection 104. Next, the coils are transported from trimming/inspection 104 to compacting 106. After compacting 106, the coils are moved to storage 108. The length of time spent on the conveyor allows the coil to cool to an acceptably low temperature before compaction and storage.

Such prior art current conveyor systems are linear and are scaled during mill design for a specific mill capacity, product mix, and rolling rate. Because of this approach, several problems exist:
1) Any equipment failure along the conveyor line brings the entire mill to a standstill.
2) Defective coils need to be removed from the line using a crane.
3) Many moving parts means high maintenance costs.
4) Such systems require constant monitoring by operators in case of failure.
5) Such systems use large amount of floor space.
6) Such systems require special setup considerations when pouring the foundations (i.e., such systems cannot be deployed on a plain concrete floor).
7) Maintenance for systems must be performed on-site.
8) Such systems are difficult to scale up for increased production.

There is currently no technology available from any mill supplier which addresses these issues. All coil handling systems consist of a fixed conveyor of some kind.

Whatever the precise merits, features, and advantages of the above cited references, none of them achieves or fulfills the purposes of the present invention.

### SUMMARY OF THE INVENTION

In one embodiment, the present invention provides an autonomous vehicle that is part of a fleet used in coil handling, the autonomous vehicle comprising: a processor on-board the autonomous vehicle communicating with an external processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location; a robotic drive to move the autonomous vehicle based on the one or more instructions received from the external processor; and a set of gripping mechanisms receiving the one or more instructions and operating in the following coil storage modes: a vertical mode, a horizontal mode, and a hybrid mode in which the coil is held at an acute angle from the vertical.

In another embodiment, the present invention provides an autonomous vehicle that is part of a fleet used in coil handling, the autonomous vehicle comprising: a processor on-board the autonomous vehicle communicating with an external Artificial Intelligence (AI) processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location; a robotic drive to move the autonomous vehicle based on the one or more instructions received from the external AI processor; and a set of gripping mechanisms receiving the one or more instructions and operating in the following coil storage modes: a vertical mode, a horizontal mode, and a hybrid mode in which the coil is held at an acute angle from the vertical.

In yet another embodiment, the present invention provides an autonomous vehicle that is part of a fleet used in coil handling, the autonomous vehicle comprising: a processor on-board the autonomous vehicle communicating with an external Artificial Intelligence (AI) processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location; a robotic drive to move the autonomous vehicle based on the one or more instructions received from the external AI processor; and a set of gripping mechanisms receiving the one or more instructions and operating in the following coil storage modes: a vertical mode, a horizontal mode, or a hybrid mode in which the coil is held at an acute angle from the vertical, wherein in the vertical mode, at least one coil stem is retained vertically on top of the set of gripping mechanisms to store the coil in a vertical configuration and, in the horizontal mode, the coil is retained in a horizontal configuration between the set of gripping mechanisms and, in the hybrid mode, the coil is held at an acute angle from the vertical.

An artificial intelligence (AI) hub for use in coil handling using a plurality of automated guided vehicles (AGVs) comprises: a processor; a storage storing a plurality of instructions which when executed by the processor automates operation of a plurality of AGVs, the storage comprising: computer readable program code receiving one or more equipment signals; computer readable program code generating a task list comprising one or more tasks from the one or more equipment signals; computer readable program code weighting the one or more tasks using weighting function and outputting a weighted task list based on task criticality; computer readable program code assigning a best AGV among the plurality of AGVs for each of the one or more tasks in the weighted task list.

### BRIEF DESCRIPTION OF THE DRAWINGS

FIG. 1 depicts how coils are transported in a linear fashion in prior art systems.

FIG. 2 depicts a flow chart of how tasks are assigned in the present invention.

FIGS. 3A-B depict a sample vehicle mockup showing unique cradle and grippers which will allow the vehicle to carry coils in multiple configurations without damaging the coil via scratching or crimping or shifting the coil package.

FIGS. 4A-C depicts a vehicle as per another embodiment wherein a larger vehicle is designed to lift the coil as a forklift does.

FIG. 5 is an arrangement of a simple railroad car style bump connector for removing “dead” vehicles”

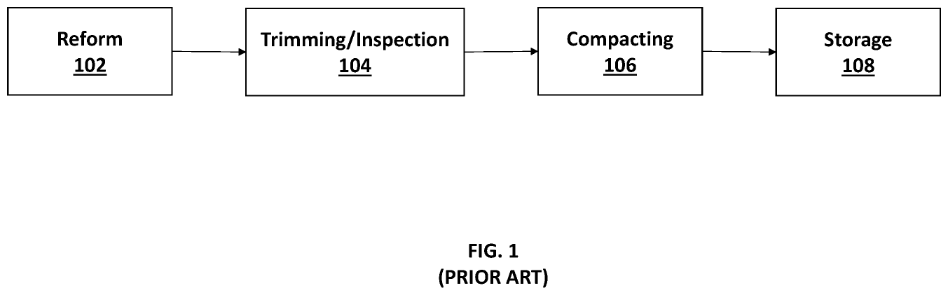

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention addresses the numerous disadvantages noted in the previous section by providing a system with a dynamic and easily configurable fleet of artificial intelligence (AI) driven autonomous vehicle “robots” to convey coils. Some of the advantages achieved by the system and method of the present invention include, but are not limited to, the following:

1) The present invention's system and method eliminate approximately 90% of moving parts.

2) The present invention's system and method reduce costs of a coil handling system.

3) The present invention's system and method allow an implementing organization to reconfigure systems, as needed, on the fly to support increased production.

4) The present invention's system and method, when implemented, allows an organization to avoid mill-wide shutdowns in the event of equipment failure or cobble.

5) The present invention's system and method, when implemented, allows an organization to reduce maintenance costs.

6) The present invention's system and method, when implemented, allows an organization to expand product portfolio into warehouse management as well as coil handling.

The present invention's autonomous coil handling system solves the problems of the linear conveyor by eliminating it entirely. Instead, coils are conveyed using a fleet of battery-driven electric vehicles linked to a centralized Artificial Intelligence (AI) processor. With the present invention's nonlinear system, greater flexibility is achieved. Eliminating most moving parts also solves the issue of maintenance costs and downtime.

Some of the advantages of the present invention include, but are not limited to:
1) The present invention's autonomous coil handling system and method uses less floor space than existing systems in new builds.
2) The present invention's autonomous coil handling system eliminates about 90% of moving parts (when compared to prior art systems).
3) Failure of one vehicle in the present invention's autonomous coil handling system does not stop production.
4) Modular nature of the system enables an implementing organization to scale up production in an effortless manner by adding more vehicles, eliminating production bottlenecks.
5) The present invention's autonomous coil handling system uses AI and can self-monitor and handle simple exceptions without human intervention (such as removal of defective coils).
6) The present invention's autonomous coil handling system allow for vehicle maintenance to be performed off-line.
7) The present invention's autonomous coil handling system works with existing equipment allowing easier integration.
8) The present invention's autonomous coil handling system is easy to reconfigure for production changes (e.g., one only needs to adjust software inputs, not equipment).
9) The present invention's autonomous coil handling system reduces manpower requirements for maintenance and operation.
10) The present invention's autonomous coil handling system can be easily integrated with plan-wide digitalization systems.
11) The present invention's autonomous coil handling system saves substantial costs over existing equipment.

Autonomous Fleet of Vehicles and AI Algorithm for Controlling the Fleet of Vehicles

In one embodiment, the present invention provides an autonomous vehicle that is part of a fleet used in coil handling, the autonomous vehicle comprising: a processor on-board the autonomous vehicle communicating with an external processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location; a robotic drive to move the autonomous vehicle based on the one or more instructions received from the external processor; and a set of gripping mechanisms receiving the one or more instructions and operating in the following coil storage modes: a vertical mode, a horizontal mode, or a hybrid mode in which the coil is held at an acute angle from the vertical.

In another embodiment, the present invention provides an autonomous vehicle that is part of a fleet used in coil handling, the autonomous vehicle comprising: a processor on-board the autonomous vehicle communicating with an external Artificial Intelligence (AI) processor, the on-board processor receiving and executing one or more instructions for automated operation of the autonomous vehicle, the one or more instructions instructing the autonomous vehicle to handle one or more of the following coil handling tasks to move to a coil: moving the coil after a reform stage, moving the coil after a trimming/inspection stage, moving the coil after a compacting stage, and moving coil to a storage location; a robotic drive to move the autonomous vehicle based on the one or more instructions received from the external AI processor; and a set of gripping mechanisms receiving the one or more instructions and operating in the following coil storage modes: a vertical mode, a horizontal mode, or a hybrid mode in which the coil is held at an acute angle from the vertical.

In yet another embodiment, the present invention provides an autonomous vehicle that is part of a fleet used in coil handling, the autonomous vehicle comprising: a processor on-board the autonomous vehicle communicating with an external Artificial Intelligence (AI) processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location; a robotic drive to move the autonomous vehicle based on the one or more instructions received from the external AI processor; and a set of gripping mechanisms receiving the one or more instructions and operating in the following coil storage modes: a vertical mode, a horizontal mode, and a hybrid mode, wherein in the vertical mode, at least one coil stem is retained vertically on top of the set of gripping mechanisms to store the coil in a vertical configuration and, in the horizontal mode, the coil is retained in a horizontal configuration between the set of gripping mechanisms and, in the hybrid mode, the coil is held at an acute angle from the vertical.

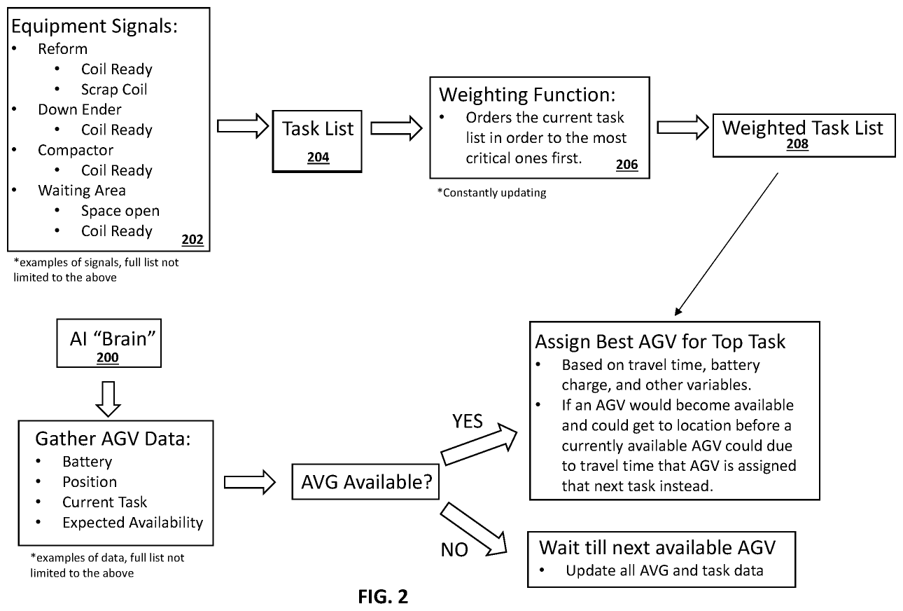

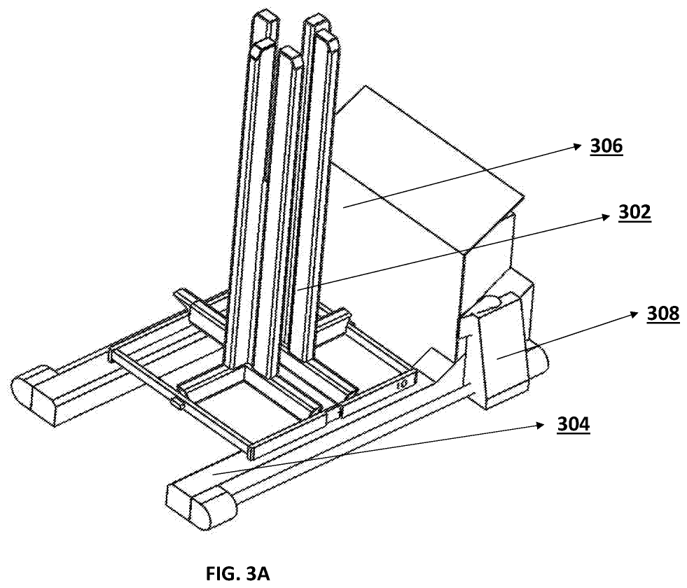

FIG. 2 depicts a flow chart of how tasks are assigned in the present invention. The present invention maintains a weighted task list which takes into account the priority of tasks. In one example, equipment signals 202 (e.g., once the coil is ready after the reform stage, a message may be received or once the coil is ready after the compactor stage, another message may be received) are received by an AI hub or AI “Brain” 200. A task list 204 is formed by the AI hub 200 based on the various received equipment signals. Next, a weighting function 206 is used by the AI hub 200 to order the tasks in task list 204 from the most critical task listed first and the least critical task listed last. The output of the weighting function 206 is a weighted task list 208 which contains the newly ordered task list based on task criticality.

The tasks in the weighted task list 208 are handled one-by-one by the AI hub based on the order of criticality. Once a task is selected, each available AGV is pinged to determine which automated guided vehicle (AGV) is best suited for this task. In one embodiment, the best suited AGV is picked based on the AGV position (i.e., distance from the task) and the battery status (e.g., fully charged, etc.) of the AGV. Other non-limiting examples of factors that may be used in picking the AGV include expected availability of a given AGV or the current task being handled by a given AGV.

The AI hub 200 collects AGV data from the plurality of AGV vehicles in the facility. The individual vehicles are in constant contact with the AI hub, their current position, direction of travel, and assigned task are all known to the AI hub at any given time.

The AI hub 200 is similarly alerted to whenever a new coil becomes available for transport, or an existing coil needs to be moved amongst the various stations on the field (trimming, cooling, compacting, etc.). These events become a list of tasks which must be completed and can be assigned relative importance in the hierarchy based on the length of time necessary to complete the task, as well as the length of time the task has “aged” in the queue, or any other factor deemed necessary for smooth operation.

This knowledge, constantly refreshed, enables the AI hub 200 to quickly decide which vehicle of the fleet is at that moment best suited to handle any new task. Thus, the vehicles do not follow a set “circuit” like the pallet stems or hooks on the current conveyors, but instead move dynamically to handle tasks as they become available.

This flexibility within the system reduces bottlenecks as the AI hub 200 can instantly assign capacity to wherever capacity is needed at the time.

This flexibility also allows for the “rules” governing the assigning of tasks to be easily modified to suit variances in production, or simply adjusted on the fly to optimize performance where necessary, which is very difficult to do with current conveyor systems.

The AI hub 200 instructs each vehicle what to do under normal operating conditions as well as basic exceptions such as removal of defective coils or docking for recharging.

Specific Vehicle Features that Allow the Safe Handling of Coils without Scratching or Damage to Vehicles

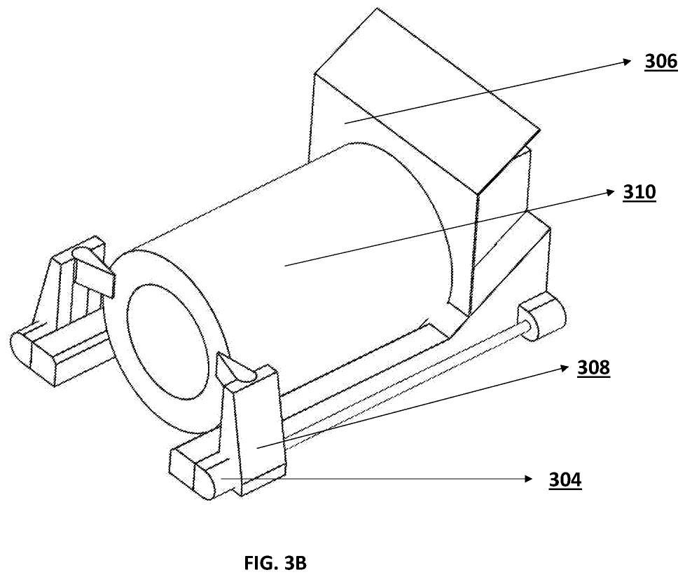

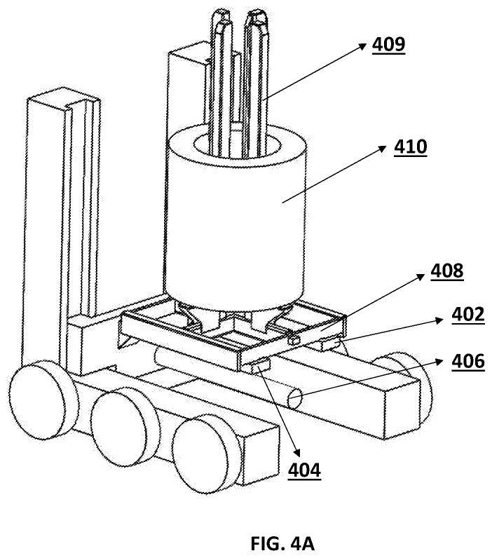

FIGS. 3A-B depict a sample vehicle mockup showing unique cradle and grippers which will allow the vehicle to carry coils in multiple configurations without damaging the coil via scratching or crimping or shifting the coil package.

FIG. 3A depicts a vehicle configuration that allows it to carry coils (not shown) vertically on stems 302. FIG. 3B depicts a vehicle configuration that allows the same vehicle to carry coils 310 without a stem.

The vehicle is equipped with a pair of specially designed grippers 304 which allow the vehicle to carry coil stems 302 (with or without a coil on) as shown in FIG. 3A, as well as horizontal coils in compacted or uncompacted state as shown in FIG. 3B.

The shape of the vehicle depicted in FIGS. 3A-B is such that it can interact with existing pallet stems

Element 308 refers to a retention paddle or gripper. Such paddles 308 are similar to transfer car paddles which are usually driven by hydraulics. Other driving mechanisms also may be used. Non-limiting examples of such driving mechanisms include, but are not limited to: an electric actuator, a screw mechanism, or a slide stage.

A heat shield 306 protects the robotic drive from heat and debris from the coil (scale or head/tail ends). The heat shield 306 can be made from any material that is durable to withstand mill conditions and has an acceptable R-value. A non-limiting example of a heat shield used may be a lightweight metal frame onto which ceramic fiber insulation material (e.g., Kaowool blanket) is attached. In one non-limiting example, the number of layers in the ceramic wool may be specifically picked to achieve a target R-value.

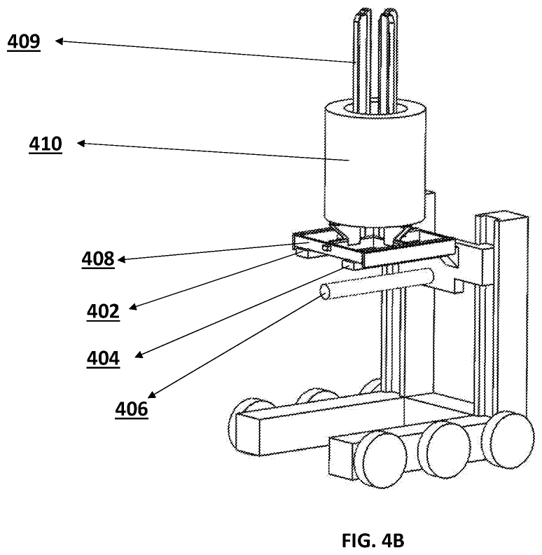

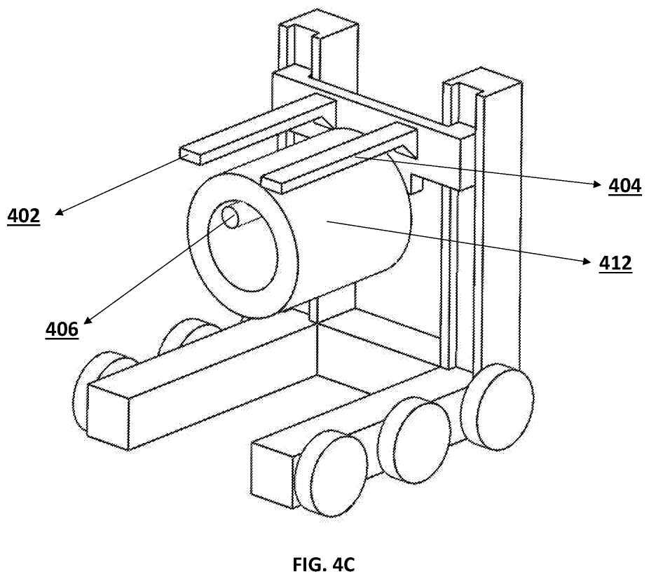

In one embodiment, if lifting capacity is needed, a larger vehicle can be designed which can also lift the coil as a forklift does. FIGS. 4A-C depict a vehicle as per this embodiment. FIG. 4A-C depicts a non-limiting example of such a vehicle, where the vehicle has three prongs (402, 404, and 406) on a vertical lifting system, two prongs, 402 and 404, would be used to interface with pallet 408, giving the vehicle the ability to raise and lower the pallet 408. FIG. 4A depicts the pallet 408 having holding stems 409 mounted thereon to hold coils 410 in a vertical configuration. FIG. 4B depicts the pallet 408 of FIG. 4A when raised to a higher elevation. FIG. 4C depicts a non-limiting example of how the third prong 406 is used to hold coils 412 in a horizontal configuration. In the non-limiting example shown in FIG. 4C, the third prong 406 is located below the other two prongs 402 and 404, providing the vehicle the ability to lift and lower coils 412 in a horizontal configuration.

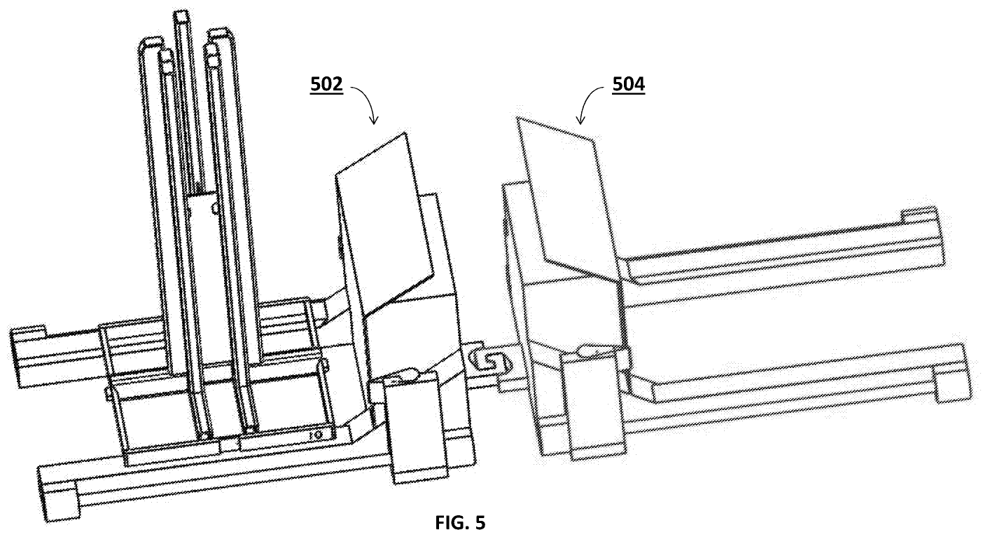

In one embodiment, the vehicles can be designed with attachments to automatically push or tow coils on a cart or to remove “dead” vehicles from the working arena. Shown in FIG. 5 is one possible arrangement of a simple railroad car style bump connector, with the implication that the operational vehicle (502) can just bump against the derelict one (504) and drag it away. Depending on the total payload capacity of the vehicles the operational vehicle could even be carrying a payload while it tows the broken vehicle off the field.

It should be noted that there are other ways the vehicles could be carried. For example, if the vehicle form is a forklift it may be able to lift the broken vehicle and carry it, or a flat vehicle like this could slide under the derelict vehicle and lift with a screw jack, or the vehicles can interlock in another way.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate to programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable BluRay® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may to refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method has been shown in the above embodiments for the effective implementation of an autonomous coil handling system. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size, materials, or specific manufacturing techniques.

1. An autonomous vehicle that is part of a fleet used in coil handling, the autonomous vehicle comprising:
a processor on-board the autonomous vehicle communicating with an external processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location;
a robotic drive to move the autonomous vehicle based on the one or more instructions received from the external processor; and
a set of gripping mechanisms receiving the one or more instructions and operating in the following coil storage modes: a vertical mode, a horizontal mode, and a hybrid mode in which the coil is held at an acute angle from the vertical.

2. The autonomous vehicle of claim 1, wherein in the vertical mode, at least one coil stem is retained vertically on top of the set of gripping mechanisms to store the coil in a vertical configuration and, in the horizontal mode, the coil is retained in a horizontal configuration between the set of gripping mechanisms.

3. The autonomous vehicle of claim 1, wherein the autonomous vehicle further comprises a heat shield the robotic drive from heat and debris from the coil.

4. The autonomous vehicle of claim 3, wherein the heat shield is made from ceramic wool.

5. The autonomous vehicle of claim 1, wherein the external processor is an artificial intelligence (AI) processor.

6. The autonomous vehicle of claim 5, wherein the AI processor determines the one or more instructions based on an AI algorithm.

7. The autonomous vehicle of claim 1, wherein the set of gripping mechanisms are engageable by pre-existing pallet stem without any additional modification.

8. An autonomous vehicle that is part of a fleet used in coil handling, the autonomous vehicle comprising:
a processor on-board the autonomous vehicle communicating with an external Artificial Intelligence (AI) processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location;
a robotic drive to move the autonomous vehicle based on the one or more instructions received from the external AI processor; and
a set of gripping mechanisms receiving the one or more instructions and operating in the following coil storage modes: a vertical mode, a horizontal mode, and a hybrid mode in which the coil is held at an acute angle from the vertical.

9. The autonomous vehicle of claim 8, wherein in the vertical mode, at least one coil stem is retained vertically on top of the set of gripping mechanisms to store the coil in a vertical configuration and, in the horizontal mode, the coil is retained in a horizontal configuration between the set of gripping mechanisms.

10. The autonomous vehicle of claim 8, wherein the autonomous vehicle further comprises a heat shield the robotic drive from heat and debris from the coil.

11. The autonomous vehicle of claim 10, wherein the heat shield is made from ceramic wool.

12. The autonomous vehicle of claim 8, wherein the AI processor determines the one or more instructions based on an AI algorithm.

13. The autonomous vehicle of claim 8, wherein the set of gripping mechanisms are engageable by pre-existing pallet stem without any additional modification.

14. An autonomous vehicle that is part of a fleet used in coil handling, the autonomous vehicle comprising:
a processor on-board the autonomous vehicle communicating with an external Artificial Intelligence (AI) processor, the on-board processor receiving and executing one or more instructions for automated operation of the autonomous vehicle, the one or more instructions instructing the autonomous vehicle to handle one or more of the following coil handling tasks to move a coil: moving the coil after a reform stage, moving the coil after a trimming/inspection stage, moving the coil after a compacting stage, and moving coil to a storage location;
a robotic drive to move the autonomous vehicle based on the one or more instructions received from the external AI processor; and
a set of gripping mechanisms receiving the one or more instructions and operating in the following coil storage modes: a vertical mode, a horizontal mode, and a hybrid mode, wherein in the vertical mode, at least one coil stem is retained vertically on top of the set of gripping mechanisms to store the coil in a vertical configuration and, in the horizontal mode, the coil is retained in a horizontal configuration between the set of gripping mechanisms and, in the hybrid mode, the coil is held at an acute angle from the vertical.

15. An artificial intelligence (AI) hub for use in coil handling using a plurality of automated guided vehicles (AGVs), the AI hub comprising:
a processor;
a storage storing a plurality of instructions which when executed by the processor automates operation of a plurality of AGVs,
the storage comprising:
computer readable program code receiving one or more equipment signals;
computer readable program code generating a task list comprising one or more tasks from the one or more equipment signals'
computer readable program code weighting the one or more tasks using weighting function and outputting a weighted task list based on task criticality;
computer readable program code assigning a best AGV among the plurality of AGVs for each of the one or more tasks in the weighted task list.

16. The AI hub of claim 15, wherein the equipment signals comprises any of the following: a first signal to pick up a coil after reform stage is complete, a second signal to pick up the coil after down ender stage is complete, a third signal to pick up the coil after compactor stage is complete, or a fourth signal to pick up the coil after the coil is ready in waiting area.

17. The AI hub of claim 15, wherein the best AGV is picked based on any of, or a combination of, the following: battery status, position, current task, and expected availability.
